(19) United States
(12) Patent Application Publication
(10) Pub. No.: US 2019/0191663 A1
(43) Pub. Date: Jun. 27, 2019

(54) BEDDING MATERIAL AND MAT FOR ANIMAL HUSBANDRY

(71) Applicants: Johann Alpers, Fredenbeck (DE); Jan Buck-Emden, Stade (DE)

(72) Inventors: Johann Alpers, Fredenbeck (DE); Jan Buck-Emden, Stade (DE)

(21) Appl. No.: 16/308,061

(22) PCT Filed: Dec. 29, 2016
(86) PCT No.: PCT/DE2016/100617

§ 371 Date: Dec. 7, 2018

(30) Foreign Application Priority Data
Jul. 1, 2016 (DE) 20 2016 103 536.8

(51) Int. Cl. A01K 1/015

(52) U.S. Cl. CPC A01K 1/0155; A01K 1/0154

(57) ABSTRACT

Bedding material for animal husbandry, in particular for freestall pens, the bedding material including a calciferous constituent and a bulk-forming constituent of straw, sawdust, oilseed rape chaff, hemp- or flax-shives, pressed fermentation residues, dung and/or compost. The calciferous constituent contains 0-25% by weight ground limestone and 75-100% by weight chamber filter cake. The chamber filter cake is produced from the elutriable super-fine constituents in a limestone wash and/or dolomite wash after the elutriable super-fine constituents have been dewatered in a chamber filter press or sedimentation tank. Also, a mat for animal husbandry, in particular for freestall pens.

The invention relates to a bedding material for animal husbandry, especially for freestall pens, consisting of a calciferous constituent and a bulk-forming constituent of straw, sawdust, rapeseed chaff, hemp- or flax-shives, pressed fermentation residues, separated liquid dung, dung, compost and/or other fibrous substances. Furthermore, the invention relates to a mat for livestock, especially for freestall pens consisting of the aforementioned bedding material.

In livestock, for example, in dairy cattle, swine breeding or poultry farms or in the horse breeding and boarding the stables are covered with bedding material to bind eliminations of the animals to improve the comfort and to support animal health.

For example, it is known in sow management to keep newborn piglets in so-called “piglet nests” or “piglet pens”. These nests are usually lined with rubber mats or hot plates, but are subjected to heavy pollution and stress due to the feces and urine of animals. Furthermore, the animals follow their instincts and begin to sniff at the hygienic nest with anxiety and begin contamination immediately.

Similar problems are also known in poultry farming in the so-called ground farming, as the poultry on the ground more often come in body contact with the feces, which promotes the spread of parasites and diseases. Furthermore, pododermatitis often occurs in the soil, especially in turkeys. Pododermatitis is caused by irritation of the skin of the foot by moisture, ammonia and the commonly used bedding materials. In this condition, minor injuries will hardly heal. Bedding material sticks in the wound and the skin becomes inflamed. Accordingly drug use is high, possibly also with the addition of antibiotics.

In dairy cattle farming, freestall pens have meanwhile prevailed. The pens are designed either as high boxes with rubber mats or as deep boxes with a bedding mat. Such bedding mats are animal friendly and hygienic and require lower investment costs than the rubber mats. However, the maintenance required is slightly higher. As a bedding material, straw predominates, however, in part, wood sawdust, rapeseed chaff, hemp- or flax-shives and/or sand are also used in different mixtures. In part also separated dung or fermentation residues are used as bedding material, wherein however the hygiene thereof is judged critically among experts.

Especially interesting is a chalk or lime straw mat known in the art, which is manufactured using lime products, such unfired lime, finely ground limestone powder or chalk lime, straw and water. In this case, the straw requirement is slightly lower and the bed mat created has greater stability than in the case of a base of pure organic bedding material, however, to adjust a pH value to 9 a substantial component of straw (pH 6-7) to lime (pH 12) required.

A disadvantage of the known lime straw mat is that relatively expensive and dry lime products are used. The lime products are mixed with straw and water in a feed mixer, in the ratio of three to five parts of lime with one part straw and one to two parts water, to a moist mass and introduced into the deep boxes. After initial filling, the mat must be solidified and supplemented with regular sprinkling at intervals of one to several weeks. Nevertheless, the annual amount of lime per pen for the production of bedding is about 400-500 kg of relatively expensive, dry lime products.

Furthermore, in the known lime straw mat or the lime bedding material it is disadvantageous that the carbonate of lime mat (limestone powder) is strongly alkaline with a pH of at least 12. Also, the mixed bedding has a pH of somewhat over 9. Accordingly, sores, skin irritation and the like occur in the animals.

It is the object of the invention, beginning with the known lime straw mat, to provide a bedding material or a mat made from this bedding material, which is economical and beneficial for animal health and soil management and significantly reduces the ongoing labor costs for the maintenance of pens.

This object is achieved with a bedding material according to the claim 1 and a mat according to claim 9.

In lime works, which produce quicklime, the limestone rock is partially washed to obtain the best qualities. In particular, the so-called pre-sift material used in limestone processing plants is washed in special facilities and sorted according to grain sizes. In both cases, a residual component remains with grain sizes <0.1 mm. This sludge, a lime/clay suspension, is used in the limestone processing plants upon dehydration to a dry matter content of approx. 80% by means of chamber filter presses or sedimentation tanks. The resulting chamber filter cake exits as a relatively solid plate from the press and disintegrates into a loose, lumpy heap. Alternatively, the sludge, consisting of a lime/clay suspension, is passed into settling tanks, so that the fine particle constituents settle to the bottom. After a sufficient drying time a loose, lumpy mass, of the same composition as the chamber filter cake, results. In the following, the mass obtained from the settling tank is also referred to as a chamber filter cake, since it has the same material composition. The chamber filter cake, which is produced in the limestone—and/or dolomite stone wash or in the cement industry, is currently not traded, but deposited on heaps, and is therefore very cheap available.

There is also limestone flour as a product of lime works. For its production, washed limestone chippings are ground by grinding to limestone flours of different fineness of <0.1 mm. This raw material is partly further processed into quicklime or used commercially in the unfired form as an additive to a fertilizer. This limestone flour consists almost completely of (Ca, Mg) CO₃ e.g. up to 95% or even 98%. Depending on the limestone origin, the calcium carbonate content or the magnesium carbonate content is greater.

Since the calciferous component predominantly or exclusively (consists 75% to 100%) of chamber filter cake, which is obtained from the accumulated precipitatable residual components at a limestone and/or dolomite stone wash, after these residual components are dewatered in a chamber filter press, a bedding material mat can be prepared, which due to the condition of the chamber filter cake has a pH of 8.5 to 9 in total thus acts only slightly alkaline (pH>8). This slightly alkaline condition leads to a significant improvement in hygiene, and at the same time does not have an aggressive effect on sensitive external organs of the animals. The slightly alkaline environment of pH slightly >8 supports microbial inhibition and improves foot and udder health. The fineness of the filter chamber cake results in a very large surface area of the material. This in turn results in a very high absorption capacity of moisture/absorbency. This property combined with the optimal pH results in the environment in which the cow experiences what is described as “cow comfort”. Microbes, for example due to fecal matter and leaking milk, can be inhibited. In addition, the lime-containing ingredient may also contain up to 25% limestone powder. Although limestone flour has a significantly higher pH of, for example, 12, by mixing in the limestone flour the desired pH value of the entire bedding material can be adjusted towards slightly higher pH values. Depending on the field of application, this can improve the microbe-inhibiting effect and, for example, lead to an optimization of the bedding material when used in poultry production. Furthermore, the added component of limestone can positively influenced the throwing power of the litter material.

The finest components from lime and/or dolomite stone washing, in addition to the lime—and/or dolomite particles, support the binding of the bedding material and thus the possibilities for producing a stable, animal-friendly lying mat. Such lying mats are characterized by the fact that for the creation of the mat 50-90% by weight, in particular 70-80% by weight calciferous ingredient are mixed with 10-50% by weight, in particular 20-30% by weight of the bulk-forming component. In addition to straw, bulk-forming components such as sawdust, wood shavings, oilseed rape chaff, hemp- or flax-shives, fermentation residues, dung, separated dung and/or compost can be used. The designation % by weight should clarify that it is the mass fraction of the respective mixture component.

For the later scattering of litter onto the lying mat, the same bedding material is used. When straw is used as a bulk-forming component, there results an annual consumption, in the case of regular replenishment of litter at intervals of 2-6 weeks, of about 800-1000 kg of ready-mixed bedding material per pen per year. Compared to the use of pure limestone powder in the known lime straw mat, when using chamber filter cake the straw requirement, that is, the need for the bulk-forming component, is significantly reduced.

In addition, the bedding material can be mixed with water to create or maintain a mat, in the case that the natural residual moisture content is insufficient. Due to the moisture-retaining component of clay minerals in the bedding material, the addition of water is not mandatory and in the aforementioned proportions by weight of calciferous ingredient and bulk-forming component maximal up to 20% by weight of water is possible.

When the chamber filter cake contains, in the dry substances, 5-30% by weight, especially 10-20% by weight, silica based compounds, the chamber filter cake has an ideal proportion of clay minerals, which are responsible for a better binding. In this case, a water addition is often omitted, since the chamber filter cake has a sufficient relative humidity. The clay minerals have better binding properties with the bulk-forming component of straw, sawdust, oilseed rape chaff, hemp- or flax-shives, and/or compost, and provide the advantage that they promote skin-conditioning and keep the teat skin supple. Overall, a good binding of the bedding material is ensured.

When bedding material from a cow is removed it is moved to dunging ponds and storage containers. Due to the very small particle size of significantly less than 0.1 mm, the bedding material remains in suspension in the liquid dung and does not precipitate, even if small lumps are still contained. The fine lime particles and clay minerals promote fermentation of the liquid dung and have an odor-binding effect, in which, for example, no malodorous hydrogen sulfide and long-chain sulfurous mucilage are formed. When liquid dung is applied to crop components, as is the case during grassland fertilization during ground covering, the dung runs off the plants better and leads to fewer feed contaminants.

Preferably, the silicate compounds are active clay minerals. Clay minerals, by virtue of their ability to bind cations, have the ability to bind ammoniac nitrogen (NH₄) and ammonia (NH₃), resulting in lower ammonia losses and a better nutrient effect of the dung. Thus, the clay minerals are advantageous not only in terms of the cohesion in the bedding material and in the formation of the bed mat, but also enhance the dung and the ease of distribution on the fields for improvement of fertility. Active clay minerals are so-called three-layer clay minerals with a tetrahedral layer-octahedral layer-tetrahedral layer (TOT), e.g., illite, smectite and vermiculite. These 2:1 clay minerals have a higher cation exchange capacity than two-layer clay minerals and therefore can deliver more nutrients such as potassium or ammonium ions to plants, while taking up in their place in their intermediate layer hydronium ions given off by the roots. A reduction of ammonia losses (NH₃) from livestock can thus be supported with this bedding material.

The chamber filter cake contains in the dry matter 40-80% CaCO₃, which corresponds to a CaO content of 30-45%. Thus, the filter cake meets the requirements of the Fertilizer Ordinance for “Limestone or dolomite limestone fertilizers”, which prescribes a minimum content of 30% CaO in the dry matter. If the processed rock is dolomite, the filter cake contains corresponding proportions of magnesium. In addition to calcium and magnesium, the filter cake contains 20-30% silicate compounds, mainly in the form of active clay minerals. In addition to the limestone component, or exclusively, the chamber filter cake may also contain dolomite components of 20-80% in the dry substance.

If the chamber filter cake contains up to 10% by weight of zeolites, in particular clinoptilolites, the animal health is further promoted. Clinoptilolites can bind toxins and prevent fungal infections of milk leaking from the udder, which is unfortunately inevitable in high performance cows before and after milking.

In order to obtain a particularly homogeneous and easily distributed ingredient, the bulk-forming ingredient is chopped straw. The chopped straw binds moisture very well and due to the shorter fiber lengths can also be very well distributed in the pen with mechanized spreading aids. In this case, an addition of up to 25% by weight limestone flour, but preferably not more than 10% by weight limestone flour, in the calciferous component improves the scaterability and flowability of the bedding material. So it should be no problem to charge conventional bedding machines with the so premixed bedding material and to allow a uniform, non-dusting reapplication of litter in the pens.

Particularly preferred is mixing 50-90% by weight, in particular 70-80% by weight calciferous ingredient with 10-50% by weight, in particular 20-30% by weight straw. In this mixing ratio, the bedding material can be easily and quickly distributed in the deep pens and be compacted into a binding mat by the livestock lying thereupon.

In the following, the invention will be described in greater detail on the basis of two exemplary embodiments.

In either embodiment a chamber filter cake from a limestone and dolomite stone wash is used, containing in the dry substance about 20-30% by weight CaMg (CO₃)₂ (dolomite stone) and approx. 40-50% by weight CaCO₃ (limestone) and 20-25% by weight silicate compounds, namely, in particular, active clay minerals and clinoptilolites.

In the first embodiment, this chamber filter cake is used exclusively as a calciferous constituent. This chamber filter cake, still containing about 20% residual moisture, is placed in a feed mixer having, for example, a volume of 22 m³, filled with straw. Therein 3750 kg chamber filter cake and 1250 kg of straw are mixed. Depending on the residual moisture of the chamber filter cake and the desired consistency of the mixture, up to 500 liters of water can be added during the mixing process.

This bedding material, which is well mixed in the feed mixer wagon, is now discharged into the pens for initial covering the freestall pen. The above mixture of 5000 kg is sufficient for, for example, 10 deep pens, so that each deep pen requires about 500 kg bedding material to create a lying mat.

Following application of the bedding material from the feed mixer wagon, the resulting substrate should be equalized in the deep pit with a rake. Optionally, a pitch or boxing planner is used.

For regular reapplication, which should take place about every two to six weeks, the same mixture as in the first filling is used, this mixture is again created in the feed mixer and applied therewith. Here, too, water addition is required only if the cohesiveness of lying mat is no longer sufficient.

The tests have shown that, with a regular supplement of pens, a consumption of about 800-1000 kg mixture per year per pen is to be calculated. The mat can last for several years with good care. The pens can be maintained with a boxing planner between bedding material intervals.

In the second embodiment, the lime-containing component contains 90% chamber filter cake and additionally 10% limestone flour.

Mixing is also done in the feed mixer, whereby 3400 kg chamber filter cake, 350 kg limestone flour and 1250 kg straw are mutually mixed. Again, depending on the residual moisture content of the chamber filter cake and the desired consistency of the mixture, up to 500 liters of water are added during the mixing process.

This bedding material is well mixed in the feed mixer and is then applied, for example, in the case of poultry, on the floor of the poultry house. This bedding forms a warm insulating layer on the floor, a dry surface with good absorption and low dust load. In addition, this bedding material shows good distribution property, so it can be scattered and can easily be evenly distributed. Since the raw materials for the bedding material are cheap to buy on the market, this bedding is economical. The particular advantage lies in the health of the feet of the poultry, especially in turkey husbandry. Zeolite contained in the bedding material binds pathogenic microbes, which are positively charged, while the zeolite is negatively charged. Furthermore, ammonia is bound, so that the house air is improved.

An important advantage over the known lime straw mat results from the elimination of the disadvantage of higher maintenance and labor costs previously attributed to the deep boxes. Simply raking out—done! The labor shows the decisive cost advantage in a direct comparison, and then in addition there is the properly dosed automatic dung dispensing lime to improve soil on the fields (and not every 3 years as usual with the corresponding disadvantages of this method).

In addition to the immediate cost advantages, it is also advantageous that by the use of the bedding material, by the discharge or runoff from the pens from the cows, up to 1000 kg of filter cake with straw components get into the dung. There, the lime particles and the clay minerals also contained in the chamber filter cake promote the fermentation of the liquid dung and have an odor-binding effect since hardly any hydrogen sulfide and long-chain sulfurous mucilage are formed. The zeolite provides for the improvement of air in the barn or house for animals and humans by the binding/reduction of ammonia. The clay minerals can bind cations, which leads to lower loss of ammonia and better nutrient effect of dung fertilizer. Furthermore, the spreading of dung fertilizer leads to a natural liming of the soil and thus provides precaution against soil acidification. The clinoptilolites contained in the chamber filter cake lead to an improvement in the soil and to improved plant growth. This in turn leads to better feed, so that mineral fertilizer can be significantly reduced and thus the nitrate load of the soil is greatly reduced.

Furthermore, a significant reduction of microbes is achieved in the region of the pen by the slightly alkaline milieu of the litter and thus the lying mat. The result is an improved animal health and thus significant reduction in the use of antibiotics. The clay minerals contained in the chamber filter cake and thus in the mat, in particular the clinoptilolites, have a health promoting effect on the outer organs of the cow, in particular nurturing the skin and promoting supple teat skin.

As the chamber filter cake contained in the mat is a natural product from washing lime and dolomitic stone, this bedding material makes the livestock industry more economical and ecologically more valuable. A comparative calculation with the lime straw mat provides substantial economic benefits to the consumer due to the low maintenance costs/labor costs, associated with the other benefits (dung improvement, soil improvement, plant growth improvement). Further cost advantages are that veterinary and drug costs are saved by improving animal health.

1. A bedding material for animal husbandry, comprising a calciferous component as well as a bulk-forming component of straw, sawdust, oilseed rape chaff, hemp- or flax-shives, pressed fermentation residues, dung and/or compost, wherein the calciferous component contains 0-25% by weight limestone powder and 75-100% by weight chamber filter cake, and wherein the chamber filter cake is produced from the elutriable super-fine constituents in a limestone wash and/or dolomite wash after said elutriable super-fine constituents have been dewatered in a chamber filter press or sedimentation tank.

2. The bedding material according to claim 1, wherein the chamber filter cake contains in the dry matter 5-30% by weight silicate compounds.

3. The bedding material according to claim 2, wherein the silicate compounds are active clay minerals.

4. The bedding material according to claim 1, wherein the chamber filter cake contains in the dry matter 40-80 weight % CaCO₃ (limestone).

5. The bedding material according to claim 1, wherein the chamber filter cake contains in the dry matter 20-80% by weight CaMg (CO₃)₂ (dolomite).

6. The bedding material according to claim 1, wherein the chamber filter cake contains up to 10% by weight of zeolites.

7. The bedding material according to claim 1, wherein the bulk-forming constituent is chopped straw.

8. The bedding material according to claim 7, wherein 50-90% by weight calciferous ingredient is mixed with 10-50% by weight of straw.

9. A mat for animal husbandry comprising the bedding material according to claim 1, wherein it consists of 50-90% by weight of the calciferous ingredient and 10-50% by weight of the bulk-forming component consists.

10. The mat according to claim 9, wherein the bedding material contains a maximum of 20% by weight water.

11. The bedding material according to claim 1, wherein the chamber filter cake contains in the dry matter 10-20% by weight silicate compounds.

12. The bedding material according to claim 1, wherein the chamber filter cake contains up to 10% by weight clinoptilolites.

13. The bedding material according to claim 7, wherein 70-80% by weight calciferous ingredient is mixed with 20-30% by weight of straw.

14. The mat according to claim 9, comprising 70-80% by weight of the calciferous ingredient and 20-30% by weight of the bulk-forming component consists.
